(19) United States
(12) Patent Application Publication
(10) Pub. No.: US 2026/0120168 A1
(43) Pub. Date: Apr. 30, 2026

(54) COLOR DESIGN PROCESS AND SYSTEM

(71) Applicant: THE LAND OF COLOR, LLC, Phoenix, AZ (US)

(72) Inventor: Lori A. Sawaya, Phoenix, AZ (US)

(21) Appl. No.: 19/433,547

(22) Filed: Dec. 26, 2025

Related U.S. Application Data
(63) Continuation-in-part of application No. 18/334,230, filed on Jun. 13, 2023, now Pat. No. 12,555,150.

(51) Int. Cl. G06Q 30/0601; G06Q 10/083; G06Q 20/10; G06T 11/10; H04W 4/80

(52) U.S. Cl. CPC G06Q 30/0631; G06Q 10/083; G06Q 20/102; G06T 11/10; H04W 4/80

(57) ABSTRACT

Processes and systems for recommending to clients colors and color schemes for design purposes based on measured existing surface colors without a color strategist traveling to the worksite. A design process includes: receiving from a client information and payment for color consulting services, shipping a portable color-measuring instrument to the client; providing instructions to the client for operating the color-measuring instrument, receiving measured color data that was obtained by the client using the color-measuring instrument on multiple surfaces, formulating color recommendations based on the measured color data, and providing the color recommendations to the client. A design system for selecting color includes apparatuses that: gather and provide information, receive payment, ship the color-measuring instrument, and formulate the colors or color scheme.

### RELATED PATENT APPLICATIONS

This patent application is a continuation-in-part of, and claims priority to, U.S. patent application Ser. No. 18/334,230, COLOR DESIGN PROCESS AND SYSTEM, filed Jun. 13, 2023, having the same sole inventor, Lori A. Sawaya, and having the same assignee. The content of the priority patent application is incorporated herein by reference.

### FIELD THE INVENTION

Various embodiments of this invention relate to processes and systems for selecting and recommending colors and color schemes, for example, for design purposes. Particular embodiments, for instance, assist clients with color selection based on existing surface colors.

### BACKGROUND OF THE INVENTION

In the past, color strategists have traveled to client locations and assisted clients in selection of colors, for example, of paint, for instance, for building interiors, exteriors, or both. Further, color-measuring instruments have been developed that color strategists have used to collect measured color data, for example, from multiple surfaces. Still further, color recommendations have been formulated, for example, by color strategists, including based on measured color data, for instance, from multiple surfaces, and color strategists have provided such color recommendations to their clients. Travel time, however, and distance, have limited how many clients a particular color strategist can serve in a given amount of time. Even further, in the past, it was often not possible to create a refined degree of color harmony with the human eye alone, for example, due to fluctuating lighting conditions, context, individual color acuity and the overall psychophysical human response to color, as examples. For instance, without a specialized process, devices, apparatuses, and tools, it was not reasonable or physically possible for a person to search innumerable paint colors, materials and products from innumerable manufacturers in order to create a color design plan, for example, based on the actual color data values of a person's home exterior or interior contents, as examples. For these and other reasons, room for improvement exists in the way color strategists serve their clients. For example, potential for benefit exists in the way measured color data is obtained, handled, and communicated, for example, color data from multiple surfaces. Potential for benefit exists, for instance, for process and systems that make color consulting more efficient, more reliable, more-easily alterable, or a combination thereof, as examples.

In addition, traditional color systems have been contemplated that classify measured color but not meaning. Certain prior art systems have relied on limited expert consensus but do not analyze cultural semantics, translate perceptual descriptors into numeric boundaries, or support automated reasoning. Prior art systems have functioned as static libraries, but not cognitive frameworks. Without an ontology that integrates appearance and/or temperature and/or stylistic language, these systems cannot scale into machine-executable color interpretation. Traditional color systems: use limited expert panels, do not analyze cultural semantics, do not convert perceptual descriptors into numeric boundaries, do not support automated reasoning, cannot produce a scalable ontology for color appearance language, or a combination thereof. Further, none provide a system for translating perceptual language into numeric tolerances. Certain prior art has used a golden ratio, for example, to generate harmonious color sets by mapping point-to-point relationships through the color space. Various systems relied on fixed geometric constructions and did not account for nonlinear behavior of hue, value/lightness, or chroma. Still further, some prior systems used CIELAB computations and rigid numerical relationships to determine harmonious color combinations. Such methods were limited because they assume uniform behavior in the color space and rely on fixed formulas.

Furthermore, various existing color systems cannot achieve cognitive translation, for example, due to various traditional color classification limitations including, for instance, scale and statistical impossibility. Existing color systems (e.g., Pantone, NCS, Munsell) rely on limited human sampling and expert consensus rather than comprehensive cultural analysis. Surveying large-scale cultural and commercial color usage across extensive digital inputs to statistically average human color perception, response, and communication patterns—then distilling this data accurately into universally applicable single-word descriptors that reflect dominant cultural consensus, is not realistically achievable at scale using conventional approaches. Prior art fails because it lacks the analytical scale to create truly comprehensive definitions. Traditional methods sample too narrowly to achieve universal applicability and lasting accuracy. Rather, needs and potential for benefit exist for systematic methodology that creates definitions with an unprecedented foundational strength. Existing systems rely on individual subjective judgment or small focus groups rather than comprehensive data synthesis. Potential for benefit exists in these and other areas that may be apparent to a person of skill in the art who has studied this document.

### SUMMARY OF PARTICULAR EMBODIMENTS OF THE INVENTION

Various embodiments are or include a method or process (e.g., a design process), for example, for selecting color. Different embodiments include different combinations of specific acts. Certain embodiments, include for instance, at least acts of: receiving information and payment from a client, providing to the client a color-measuring instrument and instructions, receiving measured color data from the client, and formulating color recommendations and providing them to the client. In various embodiments, the client obtains the measured color data using the color-measuring instrument. Various embodiments improve the way color strategists serve their clients. For example, a number of embodiments improve the way measured color data is obtained, handled, or communicated, for example, color data from multiple surfaces. Further, various embodiments provide improved process, systems, or both, for example, that make color consulting more efficient, more reliable, more-easily alterable, or a combination thereof. Even further, certain embodiments reduce travel time of color strategists, which has limited how many clients a particular color strategist can serve in a given amount of time. Particular embodiments reduce the time color strategists need to spend traveling to client locations to assist clients in selection of colors, for example, of paint, for instance, for building interiors, exteriors, or both. Various embodiments also allow clients to be served that are significantly farther away. Further, various embodiments use color-measuring instruments to collect measured color data, for example, from multiple surfaces. Still further, various embodiments provide to clients color recommendations based on measured color data from multiple surfaces. Even further, various embodiments fill a gap by providing a structured ontology designed specifically for automated aesthetic reasoning. Improvement exists in these and other areas that may be apparent to a person of skill in the art who has studied this document.

Many embodiments provide systematic methodology, for example, that creates definitions with an unprecedented foundational strength. Further, in a number of embodiments, color brackets remain reliably accurate because they're built on broad, comprehensive cultural analysis rather than limited sampling or expert opinion. In some embodiments, subjective expertise vs. objective data synthesis creates an ontology of the required depth, breadth, and statistical accuracy. Still further, in various embodiments, this is achieved through AI-powered research, analysis, and alignment of perceptual language, for example, to numerical boundaries. In a number of embodiments, a (e.g., critical) human-AI hybrid is used. While AI provides the computational power necessary for large-scale cultural analysis and pattern recognition, in various embodiments, it does not directly perceive or experience color. Rather, in a number of embodiments, a systematic human-AI methodology is used, for example, where AI performs the research and statistical analysis (e.g., which may be impossible for humans) and human experts provide the perceptual interpretation and validation (e.g., that AI may not adequately achieve. In various embodiments, the hybrid loop ensures, or at least encourages, both statistical accuracy and perceptual truth.

Specific embodiments include, for example, receiving from a client, for example, through a computer network, information about the client. Further, various embodiments include receiving from the client, for instance, through the computer network, payment, for example, for color consulting services. Still further, a number of embodiments include shipping to the client, for instance, after the payment is received, a (e.g., portable) color-measuring instrument. Even further, various embodiments include providing to the client instructions for using the color-measuring instrument. Further still, a number of embodiments include receiving from the client measured color data, for example, from multiple surfaces. For example, in various embodiments, the color data is received through the computer network, for instance, after the shipping to the client the color-measuring instrument. Moreover, in a number of embodiments, the measured color data was obtained by the client using the color-measuring instrument. Even further still, various embodiments include formulating color recommendations based on the measured color data from the multiple surfaces, providing to the client the color recommendations, or both.

Further, in particular embodiments, the information about the client includes an address (e.g., for the client), the shipping to the client includes shipping the color-measuring instrument to the address, the instructions for using the color-measuring instrument are provided to the client through the computer network, or a combination thereof, as examples. Still further, in various embodiments, the color-measuring instrument includes a colorimeter, a spectrophotometer, or both. Even further, in some embodiments, the design process, for example, is specifically for selecting color for an interior of a building. For instance, in certain embodiments, the multiple surfaces are within the interior of the building, the color recommendations are for the interior of the building, or both. On the other hand, in some embodiments, the design process is for selecting color for an exterior of a building. In particular embodiments, for example, the multiple surfaces are exterior to the building, the color recommendations are for the exterior of the building, or both. Further still, in some embodiments, the multiple surfaces include (e.g., at least one of): flooring, carpeting, rugs, furniture, upholstery, textiles, décor, pillows, artwork, counter tops, cabinetry, plumbing fixtures, and lighting fixtures. Even further still, in certain embodiments, the multiple surfaces include (e.g., at least one of): roofing material, windows, doors, gutters, downspouts, brick, stone, stucco, siding, pavers, concrete, and lighting fixtures.

In certain embodiments, the measured color data is received from the client after the measured color data is transmitted (e.g., by Bluetooth) from the (e.g., portable) color-measuring instrument to a computer, for example, operated by the client. Further, in some embodiments, the act of formulating the color recommendations is performed automatically, for instance, using at least one computer. For example, in particular embodiments, the act of formulating the color recommendations is performed (e.g., automatically) using artificial intelligence. Still further, in various embodiments, the color recommendations include (e.g., specific) product recommendations, recommendations for specific paint colors, recommendations for coordinating materials, or a combination thereof, for instance. Even further, in a number of embodiments, the design process includes providing to the client a return label, for example, for returning the color-measuring instrument, for instance, after the measured color data is obtained (e.g., by the client) from the multiple surfaces. Further still, in some embodiments, the act of formulating the color recommendations includes identifying, using, or both, hue families that the measured color data belongs to. Even further still, in particular embodiments, the act of formulating the color recommendations includes (e.g., for each measured color) using: lightness, chroma, hue, value, light reflectance value, or a combination thereof. Moreover, in a number of embodiments, the act of formulating the color recommendations includes selecting a color scheme that is (e.g., at least one of): monochromatic, complementary, split complementary, double complementary, diad, dichromatic, triadic, analogous, and tetrad. Further specific embodiments include a combination of such features.

Still other specific embodiments include various design systems, for example, for selecting color. In a number of embodiments, for example, the design system includes (e.g., at least) a (e.g., first) information gathering apparatus, for example, operating on a server, for instance, that receives (e.g., from a client), for example, through a computer network, information about the client. Further, various embodiments include a payment apparatus, for instance, operating on a server, for example, that receives from the client (e.g., through the computer network), payment, for instance, for color consulting services. Still further, a number of embodiments include a shipping apparatus, that (e.g., after the payment is received), ships (e.g., to the client) a (e.g., portable) color-measuring instrument. Even further, various embodiments include a (e.g., first) information providing apparatus (e.g., operating on a server) that provides (e.g., to the client) instructions, for example, for using the color-measuring instrument. Further still, a number of embodiments include a (e.g., second) information gathering apparatus (e.g., operating on a server) that receives (e.g., from the client), for instance, through the computer network, for example, after the shipping to the client the color-measuring instrument, measured color data from multiple surfaces. In various embodiments, the measured color data has been obtained (e.g., by the client) using the color-measuring instrument. Even further still, various embodiments include a color formulating apparatus, for example, that formulates color recommendations based on the measured color data from the multiple surfaces. Moreover, a number of embodiments include a (e.g., second) information providing apparatus (e.g., operating on a server), that provides (e.g., to the client) the color recommendations. In addition, various other embodiments of the invention are also described herein, and other benefits of certain embodiments are described herein or may be apparent to a person of skill in this area of technology.

### BRIEF DESCRIPTION OF THE DRAWINGS

FIG. 1 is a flowchart illustrating an example of a design process for selecting color;

FIG. 2 is a block diagram illustrating an example of a design system for selecting color;

FIG. 3 illustrates an example of a Color Strategist Color Wheel;

FIG. 4 illustrates one page of an example of a Paint Color DNA Table; and

FIG. 5 illustrates an example of a Fandeck.

The drawings provided herewith illustrate, among other things, examples of certain aspects of particular embodiments. Other embodiments may differ. Various embodiments may include aspects shown in the drawings, described in the specification (including the claims), known in the art, or a combination thereof, as examples.

### DETAILED DESCRIPTION OF EXAMPLES OF EMBODIMENTS

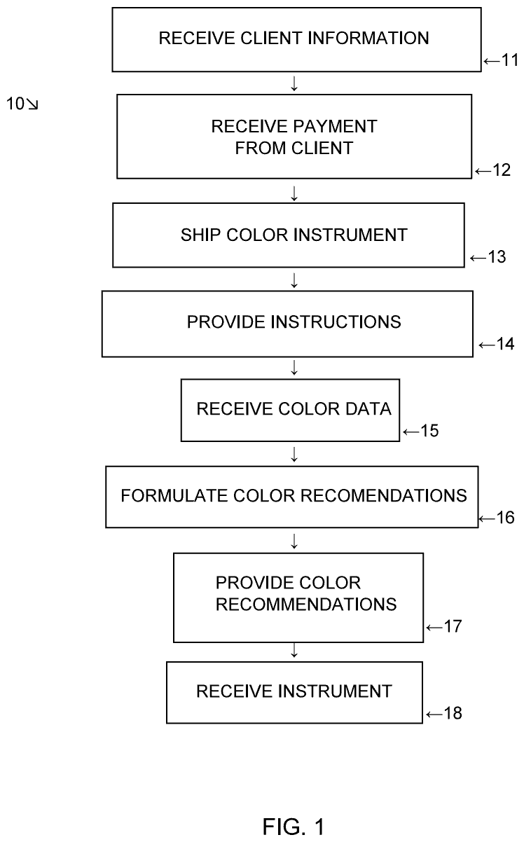

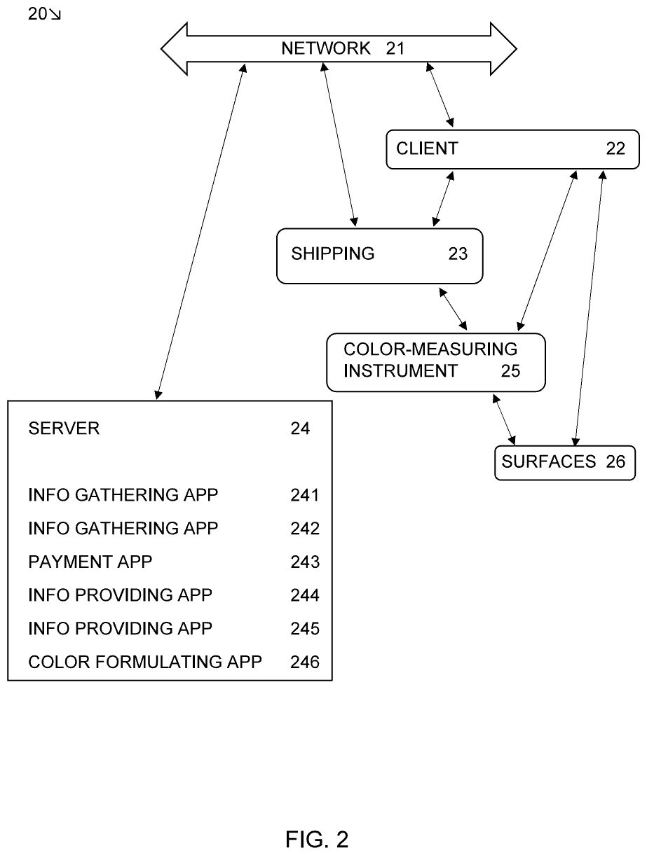

This patent application describes, among other things, various processes and systems, for example, for selecting or recommending to clients colors, color schemes, or both, for instance, for design purposes. FIGS. 1 and 2 show examples. In a number of embodiments, color schemes are based on existing surface colors measured, for example, by the client without a color strategist traveling to the worksite. In various embodiments, a color-measuring instrument is used to measure the colors, which has been shipped to the client. Described herein are examples of certain embodiments, and certain aspects thereof. Other embodiments may differ from the particular examples described in detail herein.

FIG. 1 shows design process 10 for selecting color. In the embodiment illustrated, design process 10 includes illustrated acts 11-18. These acts are performed for one client, but process 10 can be repeated for any number of different clients. Various structure involved in the acts of process 10 is illustrated in FIG. 2. Process 10 includes, for example, receiving (e.g., in act 11 shown in FIG. 1) from a client (e.g., 22 shown in FIG. 2), through a computer network (e.g., 21), information about the client. In the embodiment shown, process 10 also includes receiving (e.g., in act 12), for example, from the client, (e.g., 22, for instance, through computer network 21), payment, for example, for color consulting services (e.g., color recommendations provided in act 17 described below). Further, process 10 includes (e.g., after the payment is received in act 12) shipping (e.g., to client 22) a (e.g., portable) color-measuring instrument (e.g., 25 shown in FIG. 2). Still further, process 10 includes providing (e.g., in act 14, for example, to client 22) instructions, for instance, for using the color-measuring instrument (e.g., 25). Even further, process 10 includes receiving (e.g., in act 15, for example, from client 22, for instance, through computer network 21, for example, after the shipping in act 13, for instance, to client 22 the color-measuring instrument), measured color data, for instance, from multiple surfaces (e.g., 26). In a number of embodiments, the measured color data (e.g., received in act 15) was obtained by the client (e.g., 22) using the color-measuring instrument (e.g., 25). In various embodiments, the color-measuring instrument (e.g., 25) measures spectral data. Furthermore, in a number of embodiments, the color data or spectral data is recorded, for example, by the color-measuring instrument (e.g., 25) or by a (e.g., Bluetooth) connected device or computer, for example, operated by the client (e.g., 22). Further still, in the embodiment illustrated, process 10 includes formulating (e.g., in act 16) color recommendations, for example, based on the measured color data (e.g., received in act 15) from the multiple surfaces (e.g., 26). Even further still, in the embodiment shown, process 10 includes providing (e.g., in act 17, for example, to client 22) the color recommendations (e.g., formulated in act 16). Color recommendations may be provided (e.g., in act 17), for example, by e-mail, text, or posting on a website, as examples.

In certain embodiments, the information (e.g., received in act 11) about the client (e.g., 22) includes an address, for example, for the client. Further, in particular embodiments, the shipping (e.g., in act 13), for example, to the client (e.g., 22) includes shipping the color-measuring instrument specifically to the address (e.g., received in act 11), for instance, for client 22. Still further, in a number of embodiments, the instructions for using the color-measuring instrument are provided (e.g., in act 14), for example, to client 22, through the computer network (e.g., 21). Even further, in some embodiments, the color-measuring instrument (e.g., 25) includes a colorimeter. Still further, in various embodiments, the color-measuring instrument (e.g., 25) includes a spectrophotometer. Even further still, in certain embodiments, the color-measuring instrument (e.g., 25) includes both a colorimeter and a spectrophotometer.

In a number of embodiments, the design process (e.g., 10) is (e.g., specifically) for selecting color for an interior, for example, of a building. Further, in various embodiments, the multiple surfaces (e.g., 26, or for which color data is received in act 15) are within the interior, for instance, of the building, the color recommendations (e.g., formulated in act 16, provided in act 17, or both) are for the interior, for example, of the building, or both. In contrast, in some embodiments, the design process (e.g., 10) is (e.g., specifically) for selecting color for an exterior, for instance, of a building. Still further, in various embodiments, the multiple surfaces (e.g., 26, or for which color data is received in act 15) are exterior, for example, to the building, the color recommendations are for the exterior, for instance, of the building, or both. Even further, in a number of embodiments, the multiple surfaces (e.g., 26) include at least one of: flooring, carpeting, rugs, furniture, upholstery, textiles, décor, pillows, artwork, counter tops, cabinetry, plumbing fixtures, and lighting fixtures. Moreover, in certain embodiments, the multiple surfaces (e.g., 26) include (e.g., at least) 2, 3, 4, 5, 6, 7, 8, 9, 10, 11, 12, or all of the items identified in the previous sentence, as other examples. Further still, in some embodiments, the multiple surfaces (e.g., 26) include at least one of: roofing material, windows, doors, gutters, downspouts, brick, stone, stucco, siding, pavers, concrete, and lighting fixtures. Moreover, in particular embodiments, the multiple surfaces (e.g., 26) include (e.g., at least) 2, 3, 4, 5, 6, 7, 8, 9, 10, 11, or all of the items identified in the previous sentence, as other examples.

In some embodiments, the measured color data is received (e.g., in act 15) from the client (e.g., 22) after the measured color data has been transmitted, for example, by Bluetooth, for instance, from the color-measuring instrument (e.g., 25) to a computer operated by the client (e.g., 22). Further, in certain embodiments, the act (e.g., 16) of formulating the color recommendations is performed automatically, for example, using at least one computer (e.g., a server, desktop, laptop, tablet, or mobile phone). As used herein, “automatically” means without a person (e.g., color strategist) being involved (e.g., in formulating the color recommendations), at least for those particular color recommendations. Still further, in particular embodiments, the act (e.g., 16) of formulating the color recommendations is performed (e.g., automatically) using artificial intelligence. Even further, in various embodiments, the color recommendations (e.g., formulated in act 16, provided in act 17, or both) include (e.g., specific) product recommendations, recommendations for specific paint colors (e.g., including manufacturer's identifying information), recommendations for coordinating materials, or a combination thereof, as examples. Further still, in some embodiments, the design process (e.g., 10) includes, for example, providing to the client (e.g., 22) a return label for returning (e.g., receiving in act 18) the color-measuring instrument (e.g., 25), for example, after the measured color data (e.g., received in act 15) is obtained (e.g., by client 22 using instrument 25) from the multiple surfaces (e.g., 26).

In particular embodiments, the act (e.g., 16) of formulating the color recommendations includes identifying hue families, for example, that the measured color data belongs to, using the hue families (i.e., for formulating the color recommendations), or both. Further, in certain embodiments, the act (e.g., 16) of formulating the color recommendations includes (e.g., for each measured color, surface 26, or both), using one or more of: lightness, chroma, hue, value, and light reflectance value. Moreover, in particular embodiments, the act (e.g., 16) of formulating the color recommendations includes (e.g., at least) 2, 3, 4, or all of the items identified in the previous sentence, as other examples. Still further, in some embodiments, the act (e.g., 16) of formulating the color recommendations includes selecting a color scheme that is at least one of: monochromatic, complementary, split complementary, double complementary, diad, dichromatic, triadic, analogous, and tetrad. Moreover, in particular embodiments, the act (e.g., 16) of formulating the color recommendations includes (e.g., at least) 2, 3, 4, 5, 6, 7, 8 or all of the items identified in the previous sentence, as other examples. Even further, other embodiments include all conceivable combinations and sub combinations of the features of a design process (e.g., 10) described in the previous paragraphs. Even further still, even other embodiments include all conceivable combinations and sub combinations of the features of a design process described herein or known in the art, for example, of color selection.

FIG. 2 illustrates an example of an apparatus, assembly, or design system, for example, for selecting color. Such a system interacts with client 22 and surfaces 26 in this example, but client 22 and surfaces 26 in FIG. 2 are not considered to be part of the apparatus, assembly, or design system for selecting color. In the embodiment shown, system 20 for selecting color includes (e.g., at least) specific apparatuses that gather information, provide information, collect payment, ship (e.g., instruments), and formulate (e.g., color) recommendations. Specific apparatuses are shown in FIG. 2, but in various embodiments, different apparatuses described herein may be combined, may be divided into different components (e.g., which may be at different locations or on different servers), or both. In the embodiment illustrated, system 20 includes first information gathering apparatus 241, which is operating on server 24. In this example, information gathering apparatus 241 receives (e.g., from client 22), through computer network 21, information about client 22. An example of such information is an address, for example, of client 22. Further, computer network 21 may be or include the Internet, a mobile phone network, or both. In the embodiment shown, system 20 also includes payment apparatus 243, also operating on a server (e.g., server 24 shown). In the embodiment shown, payment apparatus 243, receives from client 22, through computer network 21, payment for color consulting services (e.g., color selection recommendations). An example of such payment is credit card payment.

In the embodiment illustrated, various apparatuses are shown (and described herein) as operating on one server (e.g., 24), but in various embodiments, different apparatuses described herein may operate on different servers. Further, particular apparatuses shown or described herein may operate on different servers or may be divided between multiple servers. Still further, as used herein, “a server” includes multiple servers and is not restricted to a previously mentioned server (e.g., 24). In the embodiment shown, system 20 also includes shipping apparatus 23, that may be or include, for example, a shipping company, a shipping department (e.g., within a company or an organization), storage (e.g., for color-measuring instruments), an inventory management system, etc. In the embodiment illustrated, shipping apparatus 23 ships (e.g., to client 22) color-measuring instrument 25 (e.g., after the payment is received, for instance, by payment apparatus 243).

System 20 also includes, in the embodiment shown, first information providing apparatus 244, which is also operating on a server (e.g., server 24 shown). In this example, information providing apparatus 244 provides (e.g., to client 22) instructions for using color-measuring instrument 25. Examples of how information can be provided (e.g., as described herein) include through e-mail, text, a website, or a web page, as examples. System 20 also includes, in the embodiment illustrated, second information gathering apparatus 242, operating on a server (e.g., 24 shown). In this embodiment, information gathering apparatus 242 receives (e.g., from client 22), measured color data, for example, from multiple surfaces (e.g., 26). Further, in various embodiments, the measured color data (e.g., received at information gathering apparatus 242) has been obtained (e.g., by client 22) using (e.g., portable) color-measuring instrument 25. Further still, in various embodiments, the measured color data (e.g., received at information gathering apparatus 242) has been obtained after the shipping (e.g., by shipping apparatus 23, for instance, to client 22) of color-measuring instrument 25. Even further, in the embodiment shown, the measured color data (e.g., received at information gathering apparatus 242) has been obtained through computer network 21. Still further, in the embodiment illustrated, system 20 also includes color formulating apparatus 246 that formulates color recommendations, for example, based on the measured color data from the multiple surfaces (e.g., 26, for instance, received at second information gathering apparatus 242). Even further still, in this particular embodiment, system 20 also includes second information providing apparatus 245, that provides (e.g., to client 22) the color recommendations (e.g., formulated by apparatus 246). In the embodiment shown, information providing apparatus 245 is also operating on a server (e.g., 24 shown). Moreover, specific embodiments include one or more apparatuses that provide various combinations and sub combinations of the features of a design process (e.g., 10) described herein. Even further still, even other embodiments include one or more apparatuses that provide all conceivable combinations and sub combinations of the features (e.g., of a design process) described herein or known in the art, for example, of color selection. Various apparatuses described herein, for example, include computer executable code, for example, software, for instance, that perform the various functions or roles described herein. Further, in particular embodiments, information gathering apparatuses and information providing apparatuses described herein may be combined or may be divided into smaller component parts.

Various embodiments are or include color data measurement-based color design processes (e.g., 10) and systems (e.g., 20). In various embodiments, a client (e.g., 22) purchases (e.g., in act 12, through apparatus 243, or both) color consulting services, for example, from an online store or business that performs the process (e.g., 10), operates the systems (e.g., 20), or both. In some embodiments, (e.g., in act 11, at apparatus 241, or both) client information is received, for example, an account profile, which may include, for instance, email, full name, shipping address, and phone number. In various embodiments, this information is automatically collected, for example, at a website (e.g., on server 24), for instance, upon check out. Further, in various embodiments, a color guide, for instance, describing how to measure color (e.g., using a colorimeter or spectrophotometer) is emailed (e.g., in downloaded PDF format), for example, to client 22 (e.g., in act 14, via information providing apparatus 244, or both). Still further, in various embodiments, a (e.g., portable) color measurement instrument (e.g., 25, for instance, colorimeter, spectrophotometer, or both) is sent (e.g., in act 13, via shipping apparatus 23, or both) to clients (e.g., 22), for example, via express, priority, overnight or regular mail. In a number of embodiments, services are not limited to clients (e.g., 22) in the United States, for example. Once the color measurement instrument (e.g., 25) is received, the client (e.g., 22) follows the instructions (e.g., “how to measure color guide”, for instance, provided by apparatus 244, in act 14, or both) for using the color-measuring instrument (e.g., 25). For example, the client (e.g., 22) may measure (e.g., some or all) relevant (e.g., fixed) finishes, important elements, or a combination thereof (e.g., surfaces 26), for example, as instructed. In some embodiments, the client (e.g., 22) connects the color measurement instrument (e.g., 25), for example, via Bluetooth, to the client's personal device, for instance, smartphone, tablet, or computer.

Even further, in particular embodiments, for example, for a one-on-one consult with a human color strategist, the client (e.g., 22) may email screen shots of measurements (e.g., CIE L*a*b* and/or LCh values), for instance, from the device. Alternatively, in certain embodiments, an app (e.g., on the device or on a server) may send the data (e.g., measured color data from multiple surfaces, for example, 26) (e.g., directly) to the color strategist. In some embodiments, for example, having a fully automated consult, the application's algorithm, artificial intelligence, or both, may collect and utilize the client's color data values (e.g., taken from surfaces 26), for example, to create a color design plan (e.g., in act 16, using apparatus 246, or both). In various embodiments, color designers (e.g., color strategists) or artificial intelligence (AI) (e.g., within an app or running on a server, for example, 24) is used to analyze the color data values received (e.g., at apparatus 242, in act 15, or both) in order to align the data values (e.g., measured color data from multiple surfaces, for instance, 26) with paint colors and/or other architectural, building, or décor materials, as examples. In some embodiments, an algorithm and/or artificial intelligence may align the color data values received and coordinate them (e.g., harmoniously) with paint, building materials and décor products. In various embodiments, the algorithm and/or artificial intelligence may automate steps, for example, of looking up color data values for paint colors, aligning them with the data values (e.g., measured color data from multiple surfaces, for example, captured using the instrument (e.g., 25) to measure interior or exterior elements like windows, rugs, art, etc. In particular embodiments, machine learning is used. In certain embodiments with advanced coding, the app (e.g., color formulating apparatus 246) is able to recommend (e.g., in act 17) not just paint colors that match, but also that project, as well as appropriate paint sundries, architectural coating products, décor, artwork, accessories and more. In a number of embodiments, products from multiple manufacturers can be included in the analysis (e.g., color recommendations), for example, because the products have a CIE L*a*b* value. For a wide range of products and items, such values have been measured. In various embodiments, the product delivered (e.g., in act 17, from apparatus 245, or both) to the client (e.g., 22) is a color palette plan, for example, with relevant design advice and recommendations, for instance, for specific paint color(s) and/or other coordinating architectural, building or décor materials, as examples. In particular embodiments, direct links, for example, to recommended products, may also be included (e.g., within the color recommendations).

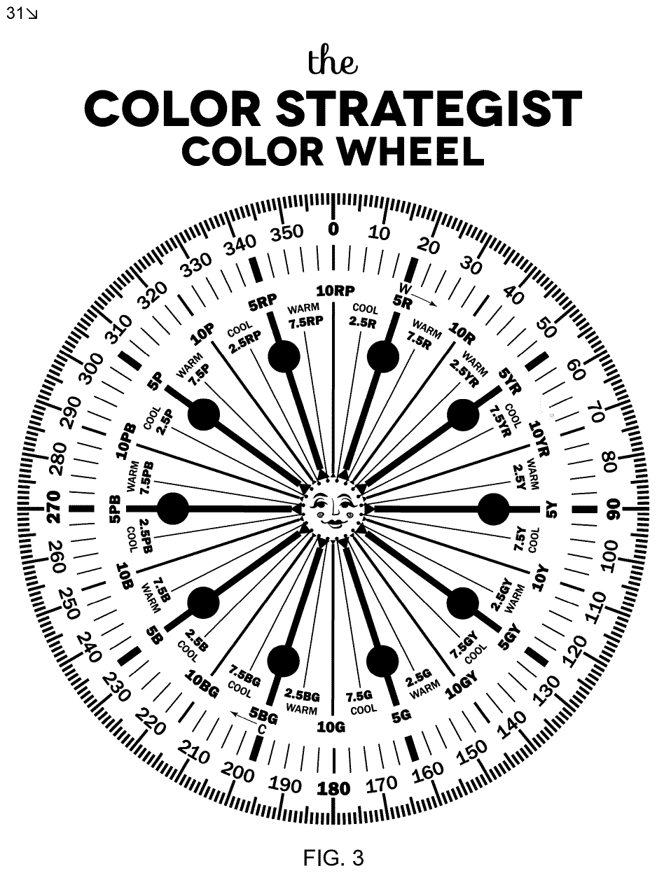

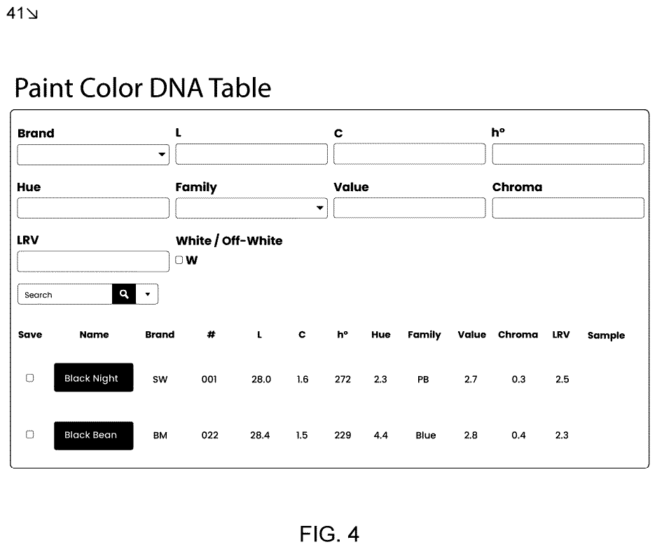

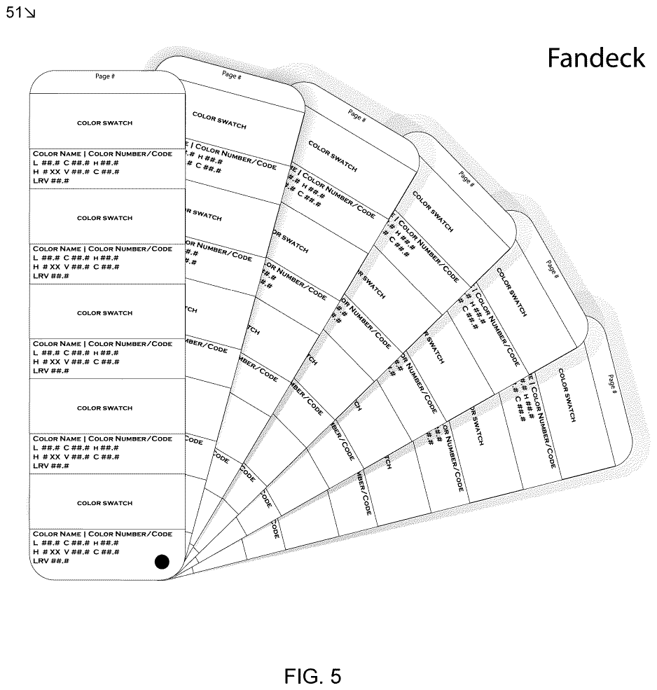

In some embodiments, the client (e.g., 22) is provided (e.g., with the color instrument shipped in act 13, through shipping apparatus 23, or both) a return label. Further, in particular embodiments, the client (e.g., 22) can reuse the original box to return the color measurement instrument (e.g., 25, for instance, received in act 18), for example, via or to the color strategist, company, or to shipping apparatus 23. Alternatively, in some embodiments, the client (e.g., 22) can choose to keep the color measurement instrument (e.g., for further use, additional cost, or both). Still further, in certain embodiments, for example, in addition to the data (e.g., measured color data from multiple surfaces, for instance, 26, for example, from the color measuring instrument 25), certain tools can be used (e.g., in act 16, in color formulating apparatus 246, or both), for instance, to formulate the color recommendations. Examples of such tools include the Color Strategist Color Wheel shown in FIG. 3, the Paint Color DNA Table shown in FIG. 4, and the Fandeck shown in FIG. 5. In various embodiments, these tools can be physical printed documents or can be digital (e.g., online or embedded within computer code). Other tools include, computer code, for instance, a mobile application (app), for example, with an algorithm, artificial intelligence, or both. In various embodiments, this tool (e.g., fully) automates the process of aligning the client's submitted color data values (e.g., measured color data from multiple surfaces 26, for example, from the color measuring instrument 25) with paint colors and/or other architectural, building or décor materials, for example.

The color wheel (e.g., shown in FIG. 3) decodes the hue portion of the color notation. Hue answers the question: “is it the right color?” Value (lightness/darkness) and Chroma (colorfulness) are secondary, in a number of embodiments, because if it's the wrong color, it doesn't matter how light/dark or colorful it is. The design and functionality of the color wheel references hue, value, and chroma ordered in 3-dimentional color space. In some embodiments, the color wheel is digitized. Further, if a color strategist knows how to read a color notation, it may be easy for the color strategist to conjure the color in her head for a point of reference. A notation may literally give the color strategist an idea of the color. Still further, in some embodiments, the actual colors of the color wheel (e.g., shown in FIG. 3) do not have to be precisely accurate, which means a digitized representation (e.g., within or used by color formulating apparatus 246) of the color wheel colors is sufficient. In addition, a black and white version of the color wheel may make as much sense to a color strategist as it does in color. Other color wheels may be less useful or even useless when digitized because it may be difficult or impossible to accurately render real-life color accurately on an illuminated screen. In some embodiments, the color wheel functionality (e.g., shown in FIG. 3) and the process (e.g., 10) described herein, may solve this issue.

In certain embodiments, the Paint Color DNA Table (e.g., shown in FIG. 4) is a WordPress plugin, for example. In particular embodiments, the DNA Table functions as a data base and/or a core part of an interface, for instance, of an app that automates strategically aligning color data values. The Fandeck (e.g., shown in FIG. 5) may be physical, digital, or both. It organizes the LCh color space colors, for example, with the LCh notation printed on a swatch of the color. In various embodiments, this may be either on the front or the back and the colors may be primarily ordered by lightness, chroma or hue, as examples. In a number of embodiments, the result is a color-trend aware, customized color palette plan, for example, based on rational, objective, tangible color data values taken directly, for instance, from the home's exterior or interior fixed finishes, important elements, or both. Further, in various embodiments, the process or system is unique, among other things, because it is a process for color specification that, in many embodiments, does not depend on human subjective opinion, unconfirmed color acuity, an intangible color sensibility, outdated (meaning unaware of current color trends), randomly curated artificial intelligence results, or a combination thereof, as examples. Still further, FIG. 5 is a black line drawing that illustrates how the Fandeck includes a color notation where: L=Lightness, C=Chroma, h=hue angle, H=Hue Family, V=Value, C=Chroma, and LRV=(Light Reflectance Value).

In various embodiments, the data (e.g., measured color data from multiple surfaces 26, for example, from the color measuring instrument 25) doesn't interpret itself. Different embodiments either require a trained, creative human linchpin to analyze and compose the results into a color design plan, or in other embodiments, analysis and results are delivered (e.g., formulated in act 16, provided in act 17, or both) via a (e.g., specially designed) algorithm and/or artificial intelligence application. Further, in a number of embodiments, the data values (e.g., measured color data from multiple surfaces, for instance, 26, for example, from the color measuring instrument 25) that are aligned/coordinated may include one or more of: CIELab, LCh, and Munsell notations. These are also known as lightness, chroma, hue, value and light reflectance value. Still further, individually these are also known as attributes. In various embodiments, color attributes are aligned either manually or in an automated process. Even further, various embodiments result (e.g., formulated in act 16, provided in act 17, or both) in a harmonious color design plan. For example, some embodiments align the hue angle from the set of data received (e.g., in act 15) with The Color Strategist Color Wheel (e.g., shown in FIG. 4). Further still, some embodiments identify what hue families the items measured (e.g., measured color data from multiple surfaces, for example, 26, for instance, from the color measuring instrument 25) belong to. Even further still, in various embodiments, color harmony is based, for example, on color relationships.

Further, in a number of embodiments, once hue families are established, (e.g., classic) color relationships are mapped out (e.g., in act 16). Examples include monochromatic, complementary, split complementary, double complementary, diad, dichromatic, triadic, analogous, and tetrad color schemes. Still further, in various embodiments, chroma indicates how colorful or grayed a color appears. In some embodiments, for example, colors with the same or similar chroma values are considered (e.g., in act 16) to harmonize. Even further, in a number of embodiments, value indicates how light and bright a color looks. Still further, in some embodiments, colors with the same or similar luminance, light reflectance value, or lightness, as examples, are considered (e.g., in act 16) to harmonize. In certain embodiments, these (e.g., quantifiable) color attributes are used (e.g., in act 16) to (e.g., strategically) align the color recommendations to create harmonies, for example, with perfect pitch. This can be done (e.g., in act 16), in different embodiments, either manually or via algorithm/artificial intelligence. For example, in some color recommendations, colors within the same hue family range are considered to go together. Likewise, in some embodiments, colors with the same or similar chroma or value are considered (e.g., in act 16) to harmonize.

In some embodiments, quantifying color by three dimensions of hue, luminance (value), and chroma, for example, provides for notating and arranging color into an orderly framework of categories. For instance, whites may have a Munsell Value of 9.12 to 10.00 and a Munsell Chroma of less than 0.55, and off-whites may have a Munsell Value of 9.12 to 10.00 and a Munsell Chroma of 0.55 to 1.15. Further, light near neutrals may have a Munsell Value of 8.12 up to 9.12 and a Munsell Chroma 0.1 to 1.00, and near neutrals may have a Munsell Value of 0.1 up to 8.12 and a Munsell Chroma of 0.1 to 1.00. Still further, colors may have a Munsell Value of 0.1 up to 9.12 and a Munsell Chroma of 1.25 and up. Using these brackets, for example, along with hue, value, chroma and LRV, some embodiments include specific manual guidance and/or automated algorithms, for instance, for harmonious color schemes and design plans (e.g., formulated in act 16, provided in act 17, or both). For example, in some embodiments, in creating a white-on-white color combination, a difference of at least 0.20 in Chroma may indicate or guarantee a level of contrast so neither color of white will make the other appear dirty or dingy. In a number of embodiments, hue, value, chroma and/or LCh values are incorporated into a color design workflow that starts with evidence-based analysis (e.g., captured color measurements, for example, received in act 15, with apparatus 242, or both) of fixed finishes and important elements (e.g., surfaces 26) of interior, exterior, or both. In different embodiments, this is done manually or is automated. In some embodiments, it is manual, meaning a person is involved. In some embodiments, for example, a color strategist pulls the data together, analyzes it, and then translate it into actionable color decisions (e.g., in act 16). In various embodiments, color recommendations are provided (e.g., in act 17), for example, recommending what paint colors go well with the measured color data (e.g., received in act 15) from the multiple surfaces (e.g., 26). In particular embodiments, the process (e.g., 10, or at least acts 15, 16, and 17 are automated. Further, some embodiments include testing colors in situ, for example, with paint chips and/or samples. For example, in some embodiments, for instance, in the final steps of the process, (e.g., large) color chips are used that also include a hue/value chroma, LCh and LRV notation printed on the chip itself. In the past, color chips and samples labeled with notations were not available. In various embodiments, large color chips are either printed with special inks or painted with real paint, as examples. Many novel aspects include incorporation of prior pieces into a new process. Various embodiments include an orderly framework of color notations and tools designed to streamline and automate matching paint/products with data from the contents or structure of a person's actual home or business, for example.

The previous paragraph describes using brackets, for example, along with hue, value, chroma and LRV. Various embodiments include a bracket system, an ontology, a color cognition engine, or a combination thereof, as examples. In a number of embodiments, for instance, brackets may define appearance, define temperature, interrelate, support automation, become an ontology, or a combination thereof. Additionally, an ontology may become a cognition engine. Further, in a number of embodiments, workflow includes a (e.g., AI-based) cognition engine, for instance, to automate tasks (e.g., previously performed by a human expert). Even further, in various embodiments, the bracket and ontology systems play roles in enabling automated reasoning (e.g., in act 16). Still further, in particular embodiments, the ontology, bracket system, color cognition engine, or a combination thereof, make automated color reasoning possible or improved. Further still, some embodiments include a structured, machine executable bridge, for example, between: human perceptual color language (e.g., “airy,” “soft,” “warm,” “silvery”, or a combination thereof) and objective color measurement or classification systems (e.g., OKLCH, CIELCh, CIELAB, or Munsell HVC, or a combination thereof), including perceptually uniform and perceptually non-uniform color spaces. In various embodiments, color data from perceptually non-uniform systems may be normalized, transformed, or mapped into numeric dimensions suitable for application of bracket boundaries and automated reasoning. Even further still, in particular embodiments, this bridge is implemented, for example, through an ontology, for instance, built around numeric bracket boundaries that define how colors are classified, interpreted, and used, for example, in automated reasoning.

In many embodiments, the ontology is not merely a vocabulary list. In particular embodiments, for example, the ontology includes: a classification framework, for example, based on measurable boundaries, a translation system, for instance, for mapping measurement to meaning, a reasoning engine, for example, that enables automated, human style interpretation of color appearance and harmony, or a combination thereof (e.g., in act 16). Further, various embodiments transform color appearance language, for instance, from something vague and subjective, into something objective, numeric, repeatable, machine usable, or a combination thereof. Still further, in particular embodiments, brackets enable automation. Even further, concerning the role of brackets, terms or labels (e.g., “White,” “Off-White,” “Near Neutral,” “Neutral,” etc.) are not necessarily novel, but the methodology that underlies the terms or labels may be novel and non-obvious over the prior art. In certain embodiments, measured color data can be segmented using numeric boundaries, for example. The embodiments described herein are illustrative and do not necessarily limit the scope or extensibility of the ontology. Even further still, some embodiments anchor priority but do not necessarily limit the scope of the ontology, for instance. Particular embodiments include a refined, scalable, and systematic bracketing methodology, for example, that: moves far beyond basic color-theory terms, applies to (e.g., all) perceptual language (e.g., including stylistic, cultural, and emotional descriptors), integrates psychological temperature and appearance semantics, forms the backbone of a full color cognition engine, or a combination thereof.

In a number of embodiments, brackets (e.g., within an expanded ontology) are numeric boundary ranges within color spaces expressed in numeric dimensions. Further, in particular embodiments, the brackets define the measurable conditions under which a color can be assigned a specific semantic descriptor. Still further, in certain embodiments, each bracket category corresponds to a measurable region, for example, in one or more color models or representations, for instance, defined by numeric boundaries (e.g., value, chroma, hue family, L*, C*, hue angle). Further still, in particular embodiments, each bracket category corresponds to a perceptual meaning, for instance, grounded in human usage or cultural semantics, for example, allowing subjective descriptors (e.g., airy, earthy, smoky) to be mapped to objective measurement. Even further, in certain embodiments, each bracket category corresponds to a classification rule, for example, used by the system's reasoning engine (e.g., 245), for instance, determining when a measured or derived color should be assigned to that bracket category. Even further still, in some embodiments, each bracket category corresponds to a boundary-based grouping structure, for example, that determines whether two colors should be treated as belonging to the same semantic or functional group based on shared bracket membership, rather than pairwise distance calculations. Examples described herein (e.g., wherein boundaries are representative and non limiting) include:
Whites: Value 9.12-10.00, Chroma<0.55
Off whites: Value 9.12-10.00, Chroma 0.55-1.15
Light Near Neutrals: Value 8.12-9.12, Chroma 0.1-1.00
Near Neutrals: Value 0.1-8.12, Chroma 0.1-1.00

In various embodiments, brackets do not depend on English labels. In a number of embodiments, for example, labels can change, but in particular embodiments, numeric boundaries may remain constant. Further, in some embodiments, the ontology is a scalable, expandable system, for example, that can incorporate new descriptors, new cultural language patterns, new measurement technologies, or a combination thereof, for instance, without requiring structural changes. Still further, various embodiments include: an objective appearance classification system, an objective temperature classification system, a combined ontology, an automated reasoning pipeline, a high-level human AI hybrid method (e.g., used to define and validate bracket boundaries), or a combination thereof. Further still, certain embodiments include, for example, objective psychological temperature classification. In various embodiments, warm vs. cool is used, but may historically be subjective. Certain embodiments formalize warm/cool, for example, using hue family boundaries. (e.g., as defined or derived from the Munsell system). Even further, in certain embodiments, these boundaries align with the Color Strategist Color Wheel (e.g., FIG. 3). Even further still, in particular embodiments, warm/cool boundaries are expressed numerically, for example, enabling: consistent classification, consistent interpretation, consistent palette reasoning, or a combination thereof. Moreover, in particular embodiments, the temperature classification is a first dimension in the ontology, for instance.

Some embodiments include objective appearance classification. For example, in certain embodiments, appearance descriptors (e.g., “airy,” “bold,” “smoky,” “earthy,” “soft,” etc.) are defined through numeric boundaries in one or more dimensions (e.g., Munsell Value, Munsell Chroma, hue family segments, CIELCh dimensions (L*, C*, h), or a combination thereof). Further, particular embodiments derive specific tolerances, for example, from perceptual studies, cultural semantics, or both. In some embodiments, these boundaries may be static or dynamic, adapting to local perceptual behavior as described herein. The following examples illustrate representative instantiations of such numeric boundaries and do not limit the appearance descriptors, numeric dimensions, or tolerance structures that may be used. Representative and non-limiting examples include:
Airy: Value: 9 to 10; Chroma: 0.5 to 0.75; LCh_L (Lightness): 97.4 to 90.5; LCh_C (Chroma): 7.1 to 0.6;
Bold: Value: 4 to 7.5; Chroma: 4.5 to 8; LCh_L (Lightness): 8.75 to 10; LCh_C (Chroma): 0.2 to 0.7;
Earthy: Hue Family: Yellow-Red or Yellow; Chroma: 1.5 to 4.5; Value: 3.5 to 7; LCh_L (Lightness): 8.75 to 10; and
Smoky: Value: 2.5 to 6.5; Chroma: 1 to 3; LCh_L (Lightness): 8.75 to 10; LCh_C (Chroma): 0.2 to 0.7.

Other specific names of appearance categories may be used in other embodiments, for example, for these or similar numeric boundaries. In various embodiments, appearance classification may be a second dimension in the ontology.

In certain embodiments, temperature and appearance may combine. For example, in particular embodiments, the system generates multi layered descriptors, for instance, by combining bracket results. Examples include: Warm+Soft; Cool+Muted; Warm+Earthy; and Cool+Smoky. Further, in some embodiments, this produces human style semantic outputs. Examples include: “Warm and inviting”; “Cool and calming”; “Warm earthy tones”, and “Cool smoky colors”. Still further, in some embodiments, (e.g., these) combined descriptors feed into automated palette generation, stylistic recommendations, or both. Further still, some embodiments include design style classification or ontology application. Design styles may be applications of the ontology, for instance. Even further, in certain embodiments, a design style is dynamically generated from a combination of measurable bracket outputs, for example. Representative and non-limiting examples include:
Japandi: High value, low chroma; Cool-neutral temperature; Airy, Soft, Calm brackets
Wabi Sabi: Mid/low value; Warm-neutral temperature; Earthy, Muted, Smoky brackets
Scandinavian: High value; Low/medium chroma; Cool temperature; Airy, Soft, Muted brackets
Traditional: Mid-value; Medium chroma; Warm temperature; Rich, Classic brackets
   Style definitions, for example, as described, may show how the ontology supports downstream reasoning, for instance.

Various embodiments include an automated reasoning pipeline (e.g., 245). Such a pipeline may provide (e.g., in act 16), for example, an automated workflow. In some embodiments, for instance, the embodiment may include certain steps, for example: input (e.g., measured or converted color data expressed in numeric coordinates, including OKLCh, LCh, LAB, or Munsell data); primary classification (e.g., classify temperature and/or appearance); secondary classification (e.g., determine style, mood, design role such as wall/trim/ceiling), or a combination thereof. Further, some embodiments may include, for example, a reasoning engine (e.g., that interprets meaning using the ontology); output (e.g., human readable guidance, ai ready descriptors, single color, or full palette guidance), or both. Still further, in various embodiments, the pipeline transforms the ontology, for example, from a classification tool into a (e.g., full) color cognition engine. Further still, some embodiments include a hybrid human-AI method, for instance. For example, certain embodiments include a hybrid process because defining appearance boundaries may require or benefit from computational scale, human perceptual judgment, or both. Even further, in particular embodiments, a machine component may: analyze large scale color language patterns, identify perceptual clusters, propose numeric ranges, filter (e.g., large) real world color datasets, or a combination thereof, as examples. Even further still, in certain embodiments, a human component may: verify perceptual accuracy (e.g., using real world color datasets), confirm (e.g., iconic) examples, remove mismatches, adjust ranges (e.g., as needed), or a combination thereof, for instance. Moreover, in particular embodiments, the loop continues, for example, until the bracket achieves: statistical consistency, perceptual accuracy, or both. Furthermore, in some embodiments, the final bracket definitions are integrated into the ontology. In various embodiments, the hybrid nature is beneficial in part because machines may not perceive color whereas humans may not have time available to analyze cultural data at scale. In addition, some embodiments combine (e.g., large scale) semantic analysis, measurable boundaries, hybrid validation, structured ontology, automated reasoning, or a combination (e.g., all) thereof.

Some embodiments determine or implement (or both) color bracket ranges. Further, certain embodiments include cognitive translation architecture (e.g., in act 16 or apparatus 245). Certain embodiments employ an artificial intelligence-based language or pattern analysis model, for instance, that functions as a cognitive interpreter.

In some embodiments, for example, the AI-based language model systematically processes human color language (e.g., “silvery,” “muted,” “vibrant”), for instance, through structured analysis of cultural usage patterns (e.g., spanning approximately one decade). Still further, certain embodiments then translate these perceptual descriptors into numeric expressions in one or more dimensions, including those derived from or mapped to color measurement or classification systems (e.g., CIELCh, Munsell hue/value/chroma). Further still, some embodiments include a systematic hybrid validation loop. In a number of embodiments, for example, a human-AI hybrid validation ensures each bracket achieves both statistical consistency (e.g., through comprehensive AI analysis), perceptual accuracy (e.g., through expert human verification), or both, for instance, before integration into automated systems. In particular embodiments, for instance, unlike purely automated systems or purely human subjective processes, the method implements a deliberate AI-human verification cycle. In some embodiments, for example, AI generates initial perceptual definitions, numerical parameter proposals, or both, AI filters real-world color datasets (e.g., to identify candidate matches), or a combination thereof. Even further, in some embodiments, a human validation phase may be used. Some embodiments may, for example, pressure-test numerical ranges against a color dataset, such as a Paint Color DNA Table (e.g., FIG. 4). Even further still, certain embodiments may verify perceptual accuracy (e.g., of included/excluded colors), adjust ranges (e.g., if outliers appear or iconic examples are missing), or both. Moreover, in particular embodiments, the system iteratively refines, for example, until perceptual-numerical alignment is confirmed.

In particular embodiments, human expert certification may be used. For instance, in certain embodiments, an expert confirms, for example, that the final bracket definition meets perceptual accuracy standards, approves for system integration, or both. Further, some embodiments implement a dataset integration phase. In some embodiments, for example, certified ranges are integrated into the color cognition engine. Still further, certain embodiments include a live implementation phase. In particular embodiments, for instance, brackets become available for automated consultation workflows. Even further, certain embodiments include an iterative refinement protocol. In some embodiments, for example, if validation fails, the system returns to the AI generation phase, for instance, with refined parameters, for example, creating a closed-loop improvement cycle (e.g., until certification is achieved). Further still, particular embodiments include temporal cultural synthesis. In certain embodiments, for instance, the system (e.g., uniquely) captures evolving color semantics, for example, by systematically analyzing how color language develops, for instance, across commercial, design, or cultural contexts (or a combination thereof), for example, over time (e.g., creating color definitions that reflect human color perception, interpretation, or both). Even further still, certain embodiments include a (e.g., scalable) bracket generation protocol. In various embodiments, for example, the methodology produces repeatable, standardized outputs (e.g., definitions, parameter tables, distinctions, metaphors, or a combination thereof), for instance, for each color bracket. In particular embodiments, for example, this may enable systematic creation of a color ontology, for instance, while maintaining consistency, for example, across the (e.g., entire) classification system. In a number of embodiments, the ontology is a (e.g., formal) framework, for example, that defines the concepts, categories, relationships, or a combination thereof, for instance, within a specific domain of knowledge. Moreover, in particular embodiments, the ontology structures information, for example, by establishing what entities exist, how they're classified, how they relate to each other, or a combination thereof, for instance, enabling (e.g., consistent) understanding, communication, or both, for example, within that field. Furthermore, various embodiments create a scalable method for transforming subjective human color experience into precise, actionable scientific data, for example, suitable for automated e-commerce, design, or consultation workflows, or a combination thereof.

In a number of embodiments, the AI-based cognitive interpreter serves as a cognitive bridge, for example, between language and color science. Further, in various embodiments, it surveys cultural or commercial color usage or both. For example, in particular embodiments, the AI model surveys and synthesizes approximately one decade of perceptual color usage. For instance, it may draw from design language, branding, visual culture, or a combination thereof. Some embodiments effectively capture the historical trajectory or current-day semantics (or both) of color appearance, for example, to translate human descriptors into structured, scientific parameters. Still further, in certain embodiments, synthesizing emotional or visual tone (or both) translates qualitative color impressions (e.g., emotional, visual, or both) into quantifiable scientific color metrics, for instance. Even further, certain embodiments include translating these metrics into numerical ranges expressed in one or more numeric dimensions, including those derived from or mapped to color measurement or classification systems (e.g., CIELCh, Munsell systems, or both), for instance, using logic derived from native AI training on perceptual color science, custom user instructions, or both, that may refine how appearance language is numerically mapped or validated (or both), for example, against real-world datasets. Further still, some embodiments include filtering, for example, a live dataset of real-world paint colors (e.g., Paint Color DNA Table, FIG. 4), for instance, to validate or refine (or both) the bracket, for example, using true color examples. In some embodiments, the implementation may use a proprietary dataset, but in a number of embodiments, the method is dataset-agnostic and applicable to (e.g., any) color atlas, for example, containing structured color data capable of being expressed or transformed into numeric dimensions suitable for bracket-based reasoning, for instance, in color models or representations (e.g., CIELCh or Munsell formats or both).

Moreover, various embodiments (e.g., act 16 or apparatus 245) provide standardized outputs, for example, definitions, parameter tables, distinctions, metaphors, or a combination thereof. Further, in particular embodiments, these may be repeatable, for example, for each bracket. Furthermore, in some embodiments, this loop is (e.g., deliberately) semi-automated. In various embodiments, for example, while AI can generate perceptual definitions, propose numerical ranges, filter candidate colors, or a combination thereof, final bracket alignment may be verified by a human observer, for instance, to ensure perceptual accuracy. In some embodiments, for example, this human-AI hybrid approach may be beneficial or even essential, for instance, for building the color ontology. A number of embodiments provide a foundational tool, for example, for a (e.g., scalable), automated color systems workflow. In some embodiments, a need or benefit to automate color classification workflows generated the necessity or motivation for such an intermediary cognition engine. Various embodiments combine AI-scale cultural analysis with human perceptual validation to create statistically-backed, broadly applicable color language definitions. In a number of embodiments, this results in a systematic methodology and scalable solution for cognitive color translation. Further, in some embodiments, this creates a scalable system, for example, where one can (e.g., rapidly) develop new color brackets that are both scientifically precise and aligned with how people talk about color.

Various embodiments are or include methods and systems (e.g., 10 and 20) for determining color harmony. In some embodiments, a framework is used that identifies harmonious color relationships, for example, by using (e.g., dynamic) tolerance bands, for instance, in hue, value/lightness, chroma, or a combination thereof. In a number of embodiments, a dynamic tolerance band harmony framework is utilized. Further, in certain embodiments, these tolerance bands adjust in response to perceptual behavior, numeric distribution, or both. This adjustment compensates for perceptual or mathematical nonuniformities (or both) in perceptual color spaces such as Munsell, CIELCh, or other color models. Still further, in particular embodiments, the approach produces consistent, human and machine-readable determinations of color relationships. Even further, various embodiments are particularly suited for automated workflows, AI-assisted design tools, machine-learning systems, or a combination thereof, for example, that provide scalable or computationally efficient (or both) color-harmony evaluation (e.g., in act 16 or apparatus 245). In some embodiments, color harmony tools use (e.g., static) geometric constructs or fixed point-to-point formulas. Examples include complementary hues placed directly opposite each other, triadic or tetradic formulas based on equal angular spacing, and numerical offsets applied within a color space. These approaches may assume the underlying color space behaves uniformly. In certain embodiments, however, perceptual color representations may exhibit nonlinearities. For instance, hue spacing may vary by region, and both value/lightness and chroma may compress or expand in certain parts of the space, for example, due to the underlying construction of the model and the limitations of real-world color datasets. As a result, in some embodiments, fixed geometric formulas may fail to produce harmonious results in a consistent or perceptually reliable way.

Some harmony systems may impose a structure, for example, from the outside. In some such embodiments, it is assumed that harmony can be calculated, for example, through a predetermined geometry, for instance, rather than being discovered through data-driven perceptual calibration within the color space itself. In various embodiments, the dynamic tolerance band harmony framework may take a different approach. For example, certain embodiments use dynamically calibrated tolerance bands, for instance, to determine the regions of the perceptual color space that meet the criteria for harmonious relationships (e.g., in act 16 or apparatus 245). Some embodiments, for example, include color harmony based on hue relationships, similarities in value/lightness and chroma, traditional structures such as analogous, complementary, triadic, and related schemes, or a combination thereof. Further, some embodiments provide an automated framework that allows harmony concepts to be executed programmatically. In various embodiments, the system implements and operationalizes harmony logic within a fully automated workflow, for example.

In some embodiments, dynamic tolerance bands are used, for example, in hue, value/lightness, chroma, or a combination thereof. Further, in particular embodiments, these bands can be widened or narrowed, for example, to account for local perceptual behavior, numeric distribution, or nonuniform behavior in the color space. In various embodiments, for example, rather than applying a fixed formula, the system evaluates relational harmony structures, for instance, such as analogous, complementary, split-complementary, triadic, tetradic, or monochromatic relationships, or a combination thereof. Still further, in some embodiments, for instance, after anchoring an origin color, the system examines the regions traditionally associated with each harmony structure. Even further, in certain embodiments, Harmony is identified when a candidate color falls within dynamically calibrated tolerance ranges, for example, for hue, value/lightness, chroma, or a combination thereof, for instance, in the relevant relational region. Various embodiments make color harmony perceptually grounded, adaptable, or both. Even further, some embodiments do not rely on rigid geometry or static mathematical offsets or formulas. Rather, certain embodiments use (e.g., dynamic) perceptually-informed boundaries, for example, that can be adjusted, for instance, to reflect how the color space behaves in the region surrounding the origin color. Further still, in some embodiments, including areas where hue spacing tightens or stretches, value/lightness becomes more sensitive, chroma compresses, or a combination thereof. Even further still, in particular embodiments, the result is a method for generating color harmonies that align with human visual perception and remain stable even in nonlinear or compressed areas of the color space. Moreover, in certain embodiments, operational logic and structural details allow harmony to be implemented in automated, human-guided, or AI-supported systems, for example, without adding new harmony theory.

Various embodiments provide a way to automate harmony relationships, for example, for execution in a (e.g., fully) automated design process (e.g., in act 16). In some embodiments, for instance, the process begins by anchoring an origin color. The origin may be defined by its position in a perceptual color representation, for example, using hue, value/lightness, chroma, or a combination thereof. In a number of embodiments, a (e.g., any) measurable color can serve as the origin. In various embodiments, the system supports (e.g., commonly recognized) harmony structures, for example: analogous, near-neutral or desaturated shifts, complementary, split complementary, triadic, tetradic, monochromatic or tonal sequences, or a combination thereof. Further, in some embodiments, each harmony structure corresponds to a general region or set of regions within the perceptual color model. Still further, in certain embodiments, for example, for each relational region, adjustable tolerance bands (e.g., in hue, value/lightness, chroma, or a combination thereof) provide perceptual boundaries, for instance, for evaluating harmony. In particular embodiments, for example, a candidate color qualifies as harmonious when it falls within those boundaries. Further still, in some embodiments, tolerance tiers such as “tight,” “standard,” “broad”, or a combination thereof, are examples. Various embodiments, however, are not limited to specific tier names or numeric boundaries. In various embodiments, different tiering strategies or labeling systems may be used. Even further, in a number of embodiments, these (e.g., dynamic) bands may respond to the nonlinear behavior of the color space. For example: hue bands may widen in areas where hue spacing is compressed; value bands may tighten where slight changes have high perceptual impact; chroma bands may broaden where chroma collapses or saturates unpredictably; or a combination thereof. Even further still, in particular embodiments, the adjustment may be localized, perceptual, or both, for example, not global, formulaic, or both.

In a number of embodiments, for a given relational structure, harmony may be established (e.g., in act 16 or apparatus 245) when a candidate color lies within a (e.g., dynamically calibrated) tolerance region, for example, for hue, value/lightness, chroma, or a combination thereof. Because these regions adjust to local distortions, in some embodiments, the system can identify harmonious candidates, for instance, even in areas where fixed geometric formulas fail. Further, in particular embodiments, the framework may determine the least discernible harmonious solution. This may occur, for example, when the tolerance bands have expanded just enough for a candidate to fall within the perceptual boundaries of harmony, but no further. In various embodiments, this approach respects the perceptual limits of human color discrimination and allows the system to provide the best available harmonious match, for instance, when the dataset lacks exact geometric alignments. Still further, perceptual studies show that humans evaluate color, for example, in terms of hue categories and relative differences, for instance, rather than mathematical precision. Perceptual color spaces like Munsell and CIELCh approximate these perceptual relationships but contain known distortions, especially in hue gradients and in regions where value and chroma behave irregularly, for example. Instead of viewing these distortions as obstacles, some embodiments compensate for them (e.g., directly). Dynamic tolerance bands absorb and correct for the inconsistencies, in certain embodiments, for example, by adjusting boundaries, for instance, along the three independent perceptual dimensions. In a number of embodiments, this approach aligns harmony determination with the perceptual characteristics that motivated the original development of uniform color spaces, for example, while still operating within the coordinates used in modern digital and physical color workflows. Fixed angular or mathematical offsets may only be used in particular embodiments, while various embodiments use relational regions, (e.g., dynamically adjustable) tolerance bands, or both, for example, that respond to the perceptual behavior of the space. Harmony is discovered, in a number of embodiments, through adaptive regions, for instance, rather than imposed geometry.

In particular embodiments, the (e.g., dynamic) tolerance band harmony framework differs fundamentally from prior systems in that it does not assume uniformity, it does not rely on predetermined numeric offsets, or both. Further, in some embodiments, it adapts itself to the perceptual behavior of the region where the origin color resides, for example, creating harmony regions that reflect visual rather than mathematical coherence. Advantages and Improvements over the prior art of certain embodiments include that it may adapt to perceptual nonuniformity rather than ignoring it. Still further, in some embodiments, it stabilizes harmony determination in areas where traditional formulas break down, it supports any harmony structure through relational regions rather than rigid geometry, or both. Even further, in particular embodiments, the system determines the least discernible harmonious solution based on perceptual boundaries, applies to a (e.g., any) domain where color harmony is used, or both. For example, applied domains may include digital design, physical materials, imaging, AI-driven selection tools, or a combination thereof. In various embodiments, the system provides a method that is reliable, scalable, compatible with both human and machine reasoning, or a combination thereof. Non-limiting examples include: identifying analogous candidates by widening the hue tolerance band, for example, while maintaining tight value and chroma bands. Another example is finding complementary candidates, for instance, by evaluating the region opposite the origin and adjusting all three tolerance bands until perceptual harmony is achieved. Still another example includes generating triadic or tetradic sets, for example, by applying the same relational-region process to multiple regions (e.g., simultaneously). Yet another example includes identifying tonal or monochromatic sequences, for instance, by adjusting value and chroma tolerances around the origin hue family. These examples may illustrate the flexibility of the framework. Other embodiments, however may differ, and these examples do not limit the scope of the contemplated embodiments. In various embodiments, the (e.g., dynamic) tolerance band harmony framework provides a perceptually grounded, flexible, and adaptive method for identifying harmonious color relationships. In certain embodiments employing dynamic tolerance bands in hue, value, and chroma, the system may compensate for local nonlinearities in the color space, determine harmony based on perceptual coherence rather than rigid formulas, or both. Such embodiments may distinguish a number of implementations from prior art and may enable dependable harmony determination across a wide range of applications.

Different embodiments (e.g., in act 16 or apparatus 245) define harmony as region membership (e.g., not a score), use adjustable tolerance bands in hue, value, and chroma, or both. Further, some embodiments, adapt boundaries to local nonlinearities in the color space, support (e.g.) any relational structure (e.g., analogous, complementary, triadic, etc.), or both. Still further, certain embodiments identify the least-discernible harmonious solution, are compatible with AI reasoning, are not limited to rigid formulas, or a combination thereof. Even further, various embodiments are region-based, adaptive, perceptually grounded, or a combination thereof, for example, rather than being formula-bound, static, or both. Further still, certain embodiments include or provide dynamic tolerance bands, perceptual-region harmony, or both. Even further still, in a number of embodiments, the system or method provides technological transformation, improves how color data is processed, or both. Moreover, in various embodiments, adaptive regions are used, the method changes (e.g., dynamically) in hue, value, and chroma, operates in all three perceptual dimensions, evaluates region membership, perceptual fit, or both, or a combination thereof. Furthermore, some embodiments (e.g., automatically) widen tolerance bands, perform computational transformation of measured color data, or both. Rather than being (e.g., static) geometry-driven, inflexible (e.g., using fixed formulas), or both, certain embodiments are perceptual, adaptive, computationally meaningful, or a combination thereof, for example, involving dynamic tolerance bands, harmonization (e.g., through perceptual-region adjustment), or both. Various embodiments use dynamic, adjustable tolerance regions, for instance, in hue, value, and chroma. Further, some embodiments define harmony as membership in a perceptually coherent region, adapt (e.g., automatically) when narrow ranges produce no results, anticipate probabilistic or AI-compatible reasoning, or a combination thereof. In a number of embodiments, this represents, for example, a fundamentally different model than prior systems and methods. Even further, in particular embodiments, harmony emerges from dynamically calibrated perceptual regions (e.g., rather than from fixed equations).

In a number of embodiments, color harmony structures are used, for example, based on hue, value/lightness, chroma, and classical relational schemes (e.g., analogous, complementary, or both, for instance, as described herein). In some embodiments, for example, the dynamic tolerance band harmony framework is the automation framework that converts those (e.g., already-disclosed) harmony concepts into a fully automated workflow, for instance, in the same way the ontology embodiment automates classification. In some embodiments, (e.g., traditional) harmony systems (e.g., geometric, mathematical, or rule-based) assume the underlying color space behaves uniformly. This, however, is not always a good assumption. Rather, various perceptual color models (e.g., including Munsell, CIELAB, CIELCh, and their derivatives) may contain regions where: hue spacing compresses or stretches, value sensitivity varies (e.g., dramatically), chroma collapses, expands, or clips, or a combination thereof. Because these distortions may vary by region, hue family, or both, a static harmony formula may break down. Certain embodiments solve this problem, for example, by stabilizing these localized perceptual distortions, for instance, through dynamic tolerance bands that adapt to the behavior of the space. Further, in some embodiments, harmony is shifted from: point-to-point calculations to region-based perceptual evaluation, from fixed offsets to adaptive calibration, or both. In contrast, prior systems have treated harmony as a numerical score rather than as a region, have assumed uniform behavior, or both. Certain embodiments, however, adapt harmony determination to local perceptual behavior, including nonuniformity, whereas prior art systems and methods may define harmony externally (e.g., via math), rather than internally (e.g., via perceptual regions). Still further, some embodiments adjust all three perceptual dimensions independently, escalate from narrow to broad tolerances, or both. Even further, in a number of embodiments, this is a computational transformation rather than rule execution.

In some embodiments, three (e.g., independent) calibration channels, for example, hue, value/lightness, and chroma, each have their own adjustable tolerance band. In various embodiments, these bands can: widen, tighten, hold steady, escalate (e.g., through tiers), operate independently, or a combination thereof. Further, in particular embodiments, this makes the system or method flexible, perceptually grounded, or both. An example is hue band widening. This is useful, for example, where hues visually crowd together, small numeric hue changes do not produce clear perceptual differences, or both. Another example is value band tightening. This is useful near the light and dark ends of the scale, for instance, where even slight value changes are highly noticeable. Yet another example is chroma band expansion. In low-chroma regions, for example, colors may group tightly together numerically. In some embodiments, the chroma band must widen to capture perceptual distinctions that numeric representations cannot reliably separate. Still further, in particular embodiments, the tolerance changes respond to the behavior of the color and its local region, for instance, rather than to predetermined mathematical offsets or fixed formulas. Even further, some embodiments include tolerance tiers. The following examples illustrate the behavior of the tolerance bands. These examples are non-limiting and implementation-dependent. Numeric ranges are representative and may vary. One such example is tight tier, which may have a strict hue band (e.g., ±2°-5°), a narrow value/lightness band (e.g., ±1-2 units), a narrow chroma band (e.g., ±1-2 units), or a combination thereof. This may be used, for instance, for tonal or monochromatic harmony. Another example is standard tier, which may have a moderate hue band (e.g., ±8°-12°), a moderate value band (e.g., ±3-5 units), a moderate chroma band (e.g., ±3-5 units), or a combination thereof. This may be used, for example, for analogous or near-neutral harmony. Yet another example is broad tier, which may have a wide hue band (e.g., ±18°-25°, or higher if needed), a flexible value band (e.g., ±6-10 units), a broad chroma band (e.g., ±6-10 units), or a combination thereof. This may be used, for example, for complementary, split-complementary, triadic, or tetradic harmony, or a combination thereof, or when narrower bands produce insufficient candidates. These example ranges are illustrative only and may be tuned per application, perceptual context, or machine-learning environment, as examples.

In certain embodiments, an escalation strategy may be used (e.g., in act 16 or apparatus 245), for example, moving from tight to standard to broad, for instance, when no candidates satisfy harmony constraints. This escalation strategy distinguishes certain embodiments from prior systems. In various embodiments, the ranges in an implementation may be static, data-driven, learned (e.g., ML-optimized), or a combination thereof, but the logic for progressive expansion remains consistent across many different embodiments. In a number of embodiments, for example, the system produces harmony by first anchoring the origin color (e.g., using the color's hue family, value, chroma, or a combination thereof). Further, in some embodiments, a next step is to select a relational harmony structure (e.g., analogous, complementary, split-complementary, triadic, tetradic, tonal, or a combination thereof). Still further, in particular embodiments, a third step is to define the target region or regions. For example, in some embodiments, each (e.g., traditional) harmony structure corresponds to relational regions in perceptual space. Even further, in various embodiments, dynamic tolerance bands are applied. For instance, in particular embodiments, adjustable hue, value/lightness, or chroma boundaries, or a combination thereof, shape the candidate search region. Further still, in certain embodiments, the region or band is expanded, for example, as needed. For instance, in particular embodiments, if no candidate color exists, for example, within a tight tolerance, the system or method will widen the hue, broaden the chroma, adjust the value, or a combination thereof, for instance, until the system or method finds the least discernible harmonious solution. Even further still, in some embodiments, the system expands the tolerance bands only as much as required to produce the first perceptually valid harmonious match. Moreover, in particular embodiments, the system stops expanding or broadening immediately when a candidate appears, keeping harmony as precise as possible rather than drifting into overly broad matches. This aspect is important, in some embodiments, among other things, because it constitutes a computational data-transformation process rather than an abstract idea, for example.

Various embodiments are suitable for different domains (e.g., besides just paint). For example, various color-relevant industries rely on: CIELAB, CIELCh, sRGB conversions, spectral to lab pipelines, device-independent color spaces, or a combination thereof. Further, many of these may have perceptual distortions. Still further, different embodiments apply to: digital and graphic design, imaging and photography, printing and textiles, materials and coatings, UX/UI color systems, AI recommendation engines, automated palette builders, AR/VR environments, or a combination thereof. These are in addition to uses concerning architectural coatings. In a number of embodiments that use AI, the AI does not create the logic, but rather, executes the structure input into the AI. Further still, in some embodiments, (e.g., dynamic) tolerance bands give AI: a defined perceptual space, segmented harmony regions, explicit calibration rules, probabilistic membership evaluation, a structured escalation strategy, a way to rank candidates, or a combination thereof, as examples. In particular embodiments, this allows AI to operate in support of human-originated conception. Even further, in a number of embodiments, harmony has region membership, which may be a conceptual shift. In various embodiments, for example, harmony is not specifically calculated, but rather, is located. Further still, in some embodiments, a color is harmonious if it falls inside a perceptually calibrated region formed by the dynamic tolerance bands. This distinguishes certain embodiments from various prior art systems and methods.

Even further still, particular embodiments (e.g., in act 16 or apparatus 245) include: dynamic tolerance regions (e.g., movable boundaries instead of fixed offsets); independent, multidimensional adjustment of hue, value/lightness, chroma, or a combination thereof; perceptual neighborhoods (e.g., rather than numerical target points); (e.g., automatic) escalation from narrow to broad tolerances; harmony defined as region membership (e.g., rather than formula output); region-based evaluation (e.g., instead of deterministic calculations); probabilistic or context-aware scoring; categorical hue semantics (e.g., perceptually meaningful hue families); or a combination thereof. Moreover, in particular embodiments, the framework respects perceptual hue categories (e.g., Yellow, Yellow-Red, Red), for instance, not just numeric hue angles. Furthermore, in some embodiments, dynamic tolerance bands can align to these perceptual category boundaries, enabling harmony decisions that reflect how people perceive hue transitions, (e.g., not just how a color is plotted mathematically). Additionally, various embodiments incorporate hue categories into harmony logic. Further, various embodiments include perceptual distortion correction. In some embodiments, for example, where hue spacing compresses, value sensitivity spikes, chroma collapses, or both. Still further, in a number of embodiments, the tolerance bands are adjusted to account for these local perceptual irregularities. Various embodiments adapt boundaries based on the underlying behavior of the color space.

In a number of embodiments, the dynamic tolerance band harmony framework performs a computational transformation of color data, for example, by adapting harmony determination to local perceptual behavior, including perceptual nonuniformity in color spaces (e.g., Munsell, CIELCh, or both). In many applications, traditional static formulas fail to produce desirable results, for example, because these spaces exhibit localized distortions. In some embodiments, hue spacing compresses or stretches, value sensitivity varies dramatically, chroma collapses or expands unpredictably, or a combination thereof, as examples. The framework, in a number of embodiments, stabilizes harmony determination by addressing these distortions directly. For example, in some embodiments, the hue tolerance band widens where hue spacing is compressed, the value tolerance band tightens where slight changes have high perceptual impact, the chroma tolerance band broadens where chroma collapses numerically (e.g., but is perceptually distinct), or a combination thereof. In various embodiments, the system defines harmony as region membership, for example, within dynamically adjusted, perceptually calibrated boundaries. This approach is fundamentally different from fixed geometric or scoring methods (e.g., of the prior art). Further, various embodiments transform color harmony from a fixed mathematical relationship into a perceptually adaptive, region-based evaluation system where harmony is determined by dynamically adjusting tolerance bands in hue, value, and chroma.

Specific embodiments include various design processes (e.g., 10) for selecting color. Such a process may include at least certain acts. Such acts may include, for example, receiving from a client (e.g., through a computer network), information about the client, providing to the client instructions for using a portable color-measuring instrument, and receiving from the client (e.g., through the computer network) measured color data, for example, where the measured color data was obtained by the client using the portable color-measuring instrument. Further, various embodiments include (e.g., automatically) formulating custom color palette recommendations (e.g., in act 16) based on the measured color data and providing to the client the custom color palette recommendations. Still further, in some embodiments, the information about the client includes an address for the client, the design process further includes (e.g., after the payment is received) shipping to the client the portable color-measuring instrument, and the shipping to the client includes shipping the portable color-measuring instrument to the address for the client. Even further, in particular embodiments, the receiving from the client (e.g., through the computer network), the measured color data, is accomplished after the shipping to the client the portable color-measuring instrument. Further still, in some embodiments, the design process includes receiving from the client (e.g., through the computer network), payment for color consulting services. Even further still, in certain embodiments, the measured color data is from multiple surfaces and the (e.g., automatically) formulating the custom color palette recommendations is based on the measured color data from the multiple surfaces.

Additionally, in some embodiments, the act of automatically formulating the color recommendations includes using dynamic tolerance bands in hue, value/lightness, and chroma, independent adjustment of each tolerance band (e.g., of the dynamic tolerance bands), escalation of tolerance widths, or a combination thereof. Further, in some embodiments, the act of automatically formulating the color recommendations (e.g., act 16) includes selecting harmony that is defined by membership within a calibrated region, determining a least-discernible harmonious solution, using an ontology built around numeric bracket boundaries that define how colors are classified, interpreted, and used, or a combination thereof. In various embodiments, the ontology and the dynamic tolerance band harmony framework are independently operable, such that classification may occur without harmony evaluation, and harmony evaluation may occur without reliance on semantic classification. Still further, in some embodiments, the act of automatically formulating the color recommendations includes expanding tolerance bands only as much as required to produce a first perceptually valid harmonious match, and then stopping expanding when a candidate appears, to keep harmony as precise as possible rather than drifting into overly broad matches.

Other specific embodiments include design systems (e.g., 20), for example, for selecting color. Some embodiments include, for instance, a first information gathering apparatus (e.g., operating on a server), that receives from a client (e.g., through a computer network), information about the client; a payment apparatus (e.g., operating on a server), that receives from the client (e.g., through the computer network), payment for color consulting services; and a shipping apparatus, that after the payment is received, ships to the client a portable color-measuring instrument. Further, various embodiments also include a first information providing apparatus (e.g., operating on a server), that provides to the client instructions for using the portable color-measuring instrument; a second information gathering apparatus (e.g., operating on a server), that receives from the client (e.g., through the computer network), for instance, after the shipping to the client the portable color-measuring instrument, measured color data (e.g., where the measured color data has been obtained by the client using the portable color-measuring instrument); a color formulating apparatus that automatically formulates a custom color palette (e.g., based on the measured color data); and a second information providing apparatus (e.g., apparatus 245 operating on a server), that provides to the client color recommendations (e.g., based on the custom color palette).

Various embodiments include shipping the device (e.g., color-measuring instrument 25, for example, with shipping apparatus 23, in act 13, or both), collecting measurement results (e.g., electronically), for instance, in act 15, with apparatus 242, or both), analyzing the data (e.g., manually or via algorithm or AI, for example, in application 246, act 16, or both), developing a custom color strategy (e.g., based on factual, objective color measurements, for instance, taken directly from the client's home, for example, in application 246, act 16, or both). Certain embodiments consider or use (e.g., in application 246, act 16, or both) design aesthetics, personal color preferences, natural and artificial lighting, geographic region, or a combination thereof, for example, to refine or customize an advanced color strategy (e.g., provided in act 17, by apparatus 245, or both). In some embodiments, an algorithm, artificial intelligence, or both, will render (e.g., almost immediate) coordinating color answers (e.g., provided in act 17, by apparatus 245, or both), but in particular embodiments, the process (e.g., 10) is also supplemented with access to a human color strategist, for example, if desired (e.g., by customer 22). In addition, in a number of embodiments, the process (e.g., 10) is executable at any time, is not limited by location, or both. In various embodiments, for example, this eliminates the need for an on-site, boots-on-the-ground visit (i.e., by a human color strategist). In various embodiments, the color measurement instrument (e.g., 25) is an off-the-shelf item. Several companies make (e.g., portable) color measurement devices, for example, Variable, Inc., DataColor, Colorix, and Nix (which may be trademarks, for example, registered or otherwise).

In certain embodiments, consideration of lighting includes representing perceptual lighting context using one or more categorical lighting profile vectors, rather than measured illuminant spectra or simulated appearance outcomes. Such lighting profile vectors may characterize typical environmental lighting conditions and available perceptual bandwidth, including how light quantity and quality influence how hue, value, and chroma are revealed or suppressed (e.g., in application 246, act 16, or both). For example, a lighting profile vector may describe a predominant lighting bias, such as daylight-biased conditions, balanced interior conditions, or warm interior or evening conditions, and may additionally or alternatively describe an illumination level, such as dim, moderate, or abundant lighting. In some embodiments, lighting profile vectors may further reflect regional or environmental context, particularly for exterior or daylight-exposed conditions. One or more such lighting profile vectors may be applied by the system to evaluate whether color relationships remain within tolerance relative to a reference color across differing lighting contexts, without modifying stored color measurements or predicting exact appearance.

Other embodiments include an apparatus or method of obtaining or providing an apparatus or information, for instance, that include a novel combination of the features described herein. Even further embodiments include at least one means for accomplishing at least one functional aspect described herein. The subject matter described herein includes various means for accomplishing the various functions or acts described herein or that are apparent from the structure and acts described. Each function described herein is also contemplated as a means for accomplishing that function, or where appropriate, as a step for accomplishing that function. Moreover, various embodiments include certain (e.g., combinations of) aspects described herein. All novel combinations are potential embodiments. Some embodiments may include a subset of elements described herein and various embodiments include additional elements as well.

Further, various embodiments of the subject matter described herein include various combinations of the acts, structure, components, and features described herein, shown in the drawings, or that are known in the art. Moreover, certain procedures can include acts such as manufacturing, obtaining, or providing components that perform functions described herein or in the documents that are incorporated by reference. Further, as used herein, the word “or”, except where indicated otherwise, does not imply that the alternatives listed are mutually exclusive. Even further, where alternatives are listed herein, it should be understood that in some embodiments, fewer alternatives may be available, or in particular embodiments, just one alternative may be available, as examples.

What is claimed is:

1. A design process for selecting color, the process comprising at least acts of:
receiving from a client, through a computer network, information about the client;
providing to the client instructions for using a portable color-measuring instrument;
receiving from the client, through the computer network, measured color data, wherein the measured color data was obtained by the client using the portable color-measuring instrument;
automatically formulating custom color palette recommendations based on the measured color data; and
providing to the client the custom color palette recommendations.

2. The design process of claim 1 wherein:
the information about the client includes an address for the client;
the design process further includes, after the payment is received: shipping to the client the portable color-measuring instrument;
the shipping to the client includes shipping the portable color-measuring instrument to the address for the client; and
the receiving from the client, through the computer network, the measured color data, is accomplished after the shipping to the client the portable color-measuring instrument.

3. The design process of claim 1 further comprising receiving from the client, through the computer network, payment for color consulting services.

4. The design process of claim 1 wherein the measured color data is from multiple surfaces and the automatically formulating the custom color palette recommendations is based on the measured color data from the multiple surfaces.

5. The design process of claim 4 wherein the design process is for selecting color for an interior of a building, the multiple surfaces are within the interior of the building, and the custom color palette recommendations are for the interior of the building.

6. The design process of claim 4 wherein the design process is for selecting color for an exterior of a building, the multiple surfaces are exterior to the building, and the custom color palette recommendations are for the exterior of the building.

7. The design process of claim 1 wherein the measured color data is received from the client after the measured color data is transmitted by Bluetooth from the portable color-measuring instrument to a computer operated by the client.

8. The design process of claim 1 wherein the act of automatically formulating the custom color palette recommendations is performed using artificial intelligence.

9. The design process of claim 1 wherein the custom color palette recommendations include recommendations for specific paint colors.

10. The design process of claim 1 wherein the act of automatically formulating the custom color palette recommendations comprises: identifying hue families that the measured color data belongs to; and the automatically formulating of the color recommendations comprises using the hue families.

11. The design process of claim 1 wherein the act of automatically formulating the color recommendations comprises, for each measured color, using: lightness, chroma, hue, value, and light reflectance value.

12. The design process of claim 1 wherein the act of automatically formulating the color recommendations comprises selecting a color scheme that is at least one of: monochromatic, complementary, split complementary, double complementary, diad, dichromatic, triadic, analogous, and tetrad.

13. The design process of claim 1 wherein the act of automatically formulating the color recommendations comprises using dynamic tolerance bands in hue, value/lightness, and chroma.

14. The design process of claim 13 wherein the act of automatically formulating the color recommendations comprises independent adjustment of each tolerance band of the dynamic tolerance bands.

15. The design process of claim 13 wherein the act of automatically formulating the color recommendations comprises escalation of tolerance widths.

16. The design process of claim 1 wherein the act of automatically formulating the color recommendations comprises selecting harmony that is defined by membership within a calibrated region.

17. The design process of claim 1 wherein the act of automatically formulating the color recommendations comprises determining a least-discernible harmonious solution.

18. The design process of claim 1 wherein the act of automatically formulating the color recommendations comprises using an ontology built around numeric bracket boundaries that define how colors are classified, interpreted, and used.

19. The design process of claim 1 wherein the act of automatically formulating the color recommendations comprises expanding tolerance bands only as much as required to produce a first perceptually valid harmonious match, and then stopping expanding when a candidate appears, to keep harmony as precise as possible rather than drifting into overly broad matches.

20. A design system for selecting color, the system comprising at least:
a first information gathering apparatus, operating on a server, that receives from a client, through a computer network, information about the client;
a payment apparatus, operating on a server, that receives from the client, through the computer network, payment for color consulting services;
a shipping apparatus, that after the payment is received, ships to the client a portable color-measuring instrument;
a first information providing apparatus, operating on a server, that provides to the client instructions for using the portable color-measuring instrument;
a second information gathering apparatus, operating on a server, that receives from the client, through the computer network, after the shipping to the client the portable color-measuring instrument, measured color data, wherein the measured color data has been obtained by the client using the portable color-measuring instrument;
a color formulating apparatus that automatically formulates a custom color palette based on the measured color data; and
a second information providing apparatus, operating on a server, that provides to the client color recommendations based on the custom color palette.
